(19) United States
(12) Patent Application Publication
(10) Pub. No.: US 2003/0236686 A1
(43) Pub. Date: Dec. 25, 2003

(54) System for calculating insurance premium

(75) Inventors: Kiyotaka Matsumoto, Saitama (JP); Nobuyuki Homma, Yokohama (JP); Tetsuharu Ohya, Fujisawa (JP); Shingo Ikki, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/366,491

(22) Filed: Feb. 12, 2003

(30) Foreign Application Priority Data
Jun. 21, 2002 (JP) 2002-180771

(51) Int. Cl. G06F 17/60

(52) U.S. Cl. 705/4

(57) ABSTRACT

An insurance premium calculation system calculates an insurance premium in consideration of factors other than the distance covered and the number of workdays of an automobile. In order to calculate the insurance premium in accordance with a person (or an automobile) insured more properly, equipment information relative to equipment (or parts) equipped in the automobile is inputted from a store server and a collation system calculates the insurance premium in accordance with points corresponding to each equipment. An insurance contract plan is prepared on the basis of the calculated insurance premium by an insurance company server to be informed to a customer.

### BACKGROUND OF THE INVENTION

The present invention relates to a technique of calculating a premium of insurance containing automobile insurance by means of a computer system utilizing a network.

Heretofore, in calculation of an insurance premium, the premium is calculated on the basis of information relative to a risk of payment of the insurance. In order to calculate the premium of the automobile insurance, there is a prior art used in the operation situation of an automobile. For example, JP-A-2002-024553 discloses a technique of using operation situation data including the number of workdays and the distance covered of an automobile as the calculation standard of the premium. This technique discloses an automobile management and insurance system which collects data concerning automobile information containing the “distance covered” of the automobile and calculates the insurance premium on the basis of the data.

### SUMMARY OF THE INVENTION

In the above background art, however, it is necessary to grasp the situation of the automobile by means of automobile management means at all times (every predetermined period). That is, the background art can be applied to an automobile if the traveling (operation) situation of the automobile can be managed like a rent-a-car. Accordingly, it is difficult that the background art is applied to the automobile which is used by a common driver and is not managed. In this case, it is difficult to grasp the traveling situation of the automobile and accordingly calculation of the insurance premium is also difficult.

Further, the risk of occurrence of an accident is not simply decided only by the distance covered and the number of workdays of the automobile. Accordingly, in the background art, it is difficult to calculate the insurance premium in accordance with a person (or an automobile) insured more properly.

In order to solve the above problem, the present invention is constructed as follows:

According to the present invention, equipment information relative to equipment (or parts) equipped in an automobile is inputted to calculate an insurance premium on the basis of the information. In the present invention, the insurance premium may be calculated on the basis of information indicative of the traveling situation containing the distance covered of the automobile and other information such as classes. The equipment equipped in the automobile includes equipment equipped upon purchase containing options in addition to equipment equipped after purchase of the automobile. The present invention contains notification of a next insurance plan prepared on the basis of the calculated insurance premium to a customer.

Further, the equipment information contains point information which is information for calculating the insurance premium in a correspondence manner to the equipment. The point information contains a discount rate of the insurance premium or point information corresponding to a discount amount. Moreover, the point information contains not only information itself used to calculate the insurance premium but also information for modifying information used to calculate the insurance premium and containing a class.

Further, in the present invention, the equipment information may be calculated on the basis of sales data treated by a computer apparatus managed by a store of the equipment. In such configuration, even an insurance premium for an automobile which is not managed by the computer apparatus can be calculated. The sales data contains an article identifier (ID) for identifying an article which is a purchased equipment.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram illustrating an example of a system according to an embodiment of the present invention;

FIG. 2 is a diagram showing an example of a policyholder database (DB) 21;

FIG. 3 is a diagram showing an example of purchase information 1;

FIG. 4 is a diagram showing an example of product data 3 and article data 4;

FIG. 5 is a diagram showing an example of a collation DB 31;

FIG. 6 is a diagram showing an example of an article-for-additional-service DB 32;

FIG. 7 is a diagram showing an example of a master-for-additional-service DB 33;

FIG. 8 is a diagram showing an example of an article DB 41;

FIG. 9 is a diagram showing an example of a point-to-premium correspondence table;

FIG. 10 is a diagram showing an example of a point-to-amount-claimed correspondence table 34;

FIG. 11 is a diagram showing an example of policyholder information 2;

FIG. 12 is a flowchart showing first processing in the embodiment of the present invention;

FIG. 13 is a flowchart showing second processing in the embodiment of the present invention; and

FIG. 14 is a flowchart showing third processing in the embodiment of the present invention.

### DESCRIPTION OF THE EMBODIMENTS

Embodiments of the present invention are now described with reference to the accompanying drawings.

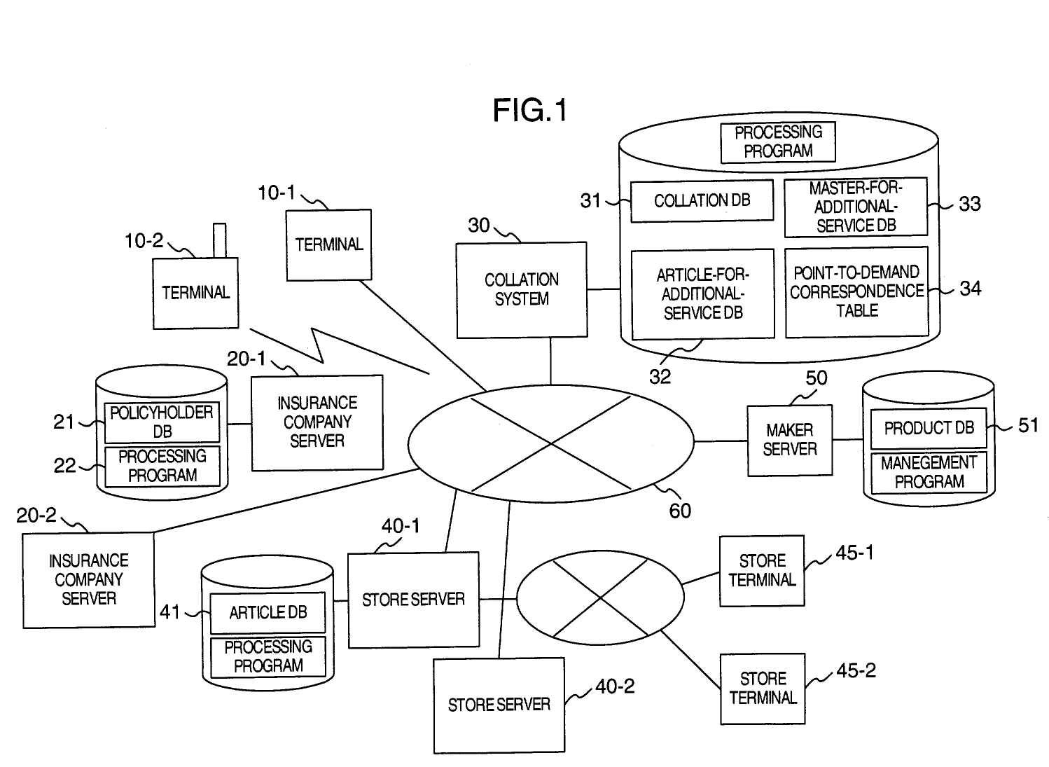

FIG. 1 is a schematic diagram illustrating a system according to an embodiment of the present invention. In the present invention, computer apparatuses are connected to each other through a network 60 including the Internet. As the computer apparatuses, there are policyholder terminals 10 utilized by policyholders or insurance contractors, insurance company servers 20 managed by insurance companies, a collation system 30 for calculating an insurance premium, store servers 40 for managing sales data of equipment and a maker server 50 managed by a production company of equipment. Two or more computer apparatuses may be provided as each kind of computer apparatuses. Further, the store servers 40 are installed in each of one or more stores. In the embodiment, there are provided one or more store terminals 45 connected to the store servers 40. Information relative to sale containing sales data can be inputted by means of the store terminals 45 and the store terminals 45 contain registers, POS (Point of Sale) terminals and the like.

Further, the computer apparatuses are to execute information processing in accordance with programs. Accordingly, the computer apparatuses each include a storage apparatus for storing programs and data, a memory for developing the programs stored in the storage apparatus and a processing unit (processor) for executing information processing in accordance with the programs. Further, the storage apparatus may be connected to the computer apparatus.

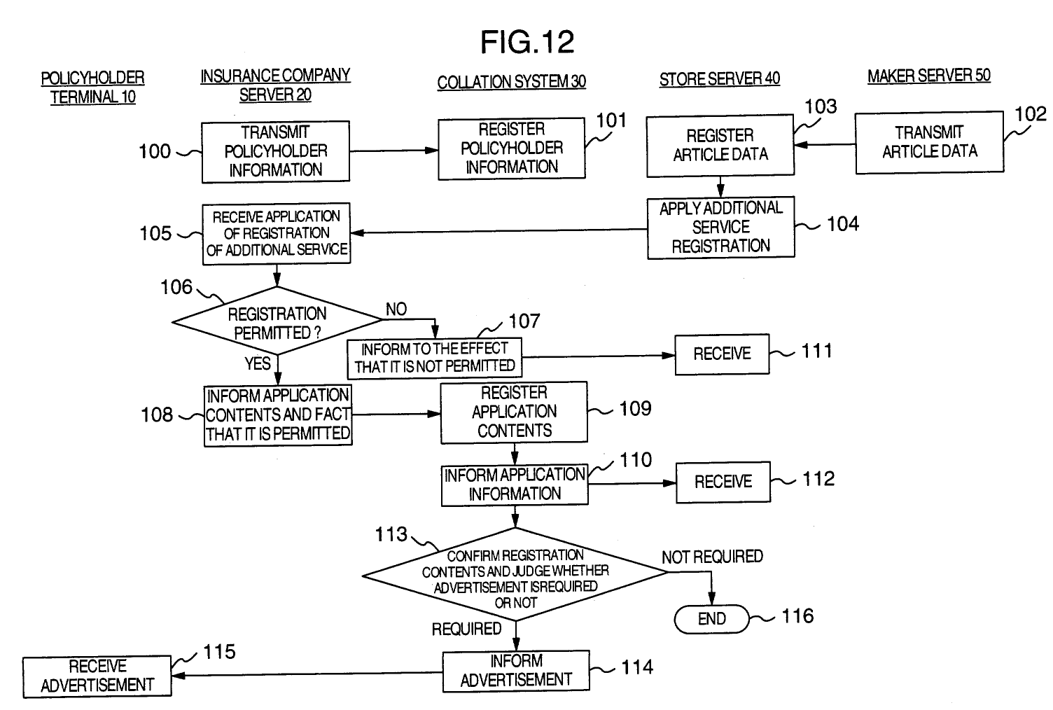

Referring now to a flowchart shown in FIG. 12, first processing in the embodiment is described. The first processing represents processing at a preparatory stage for realizing point service.

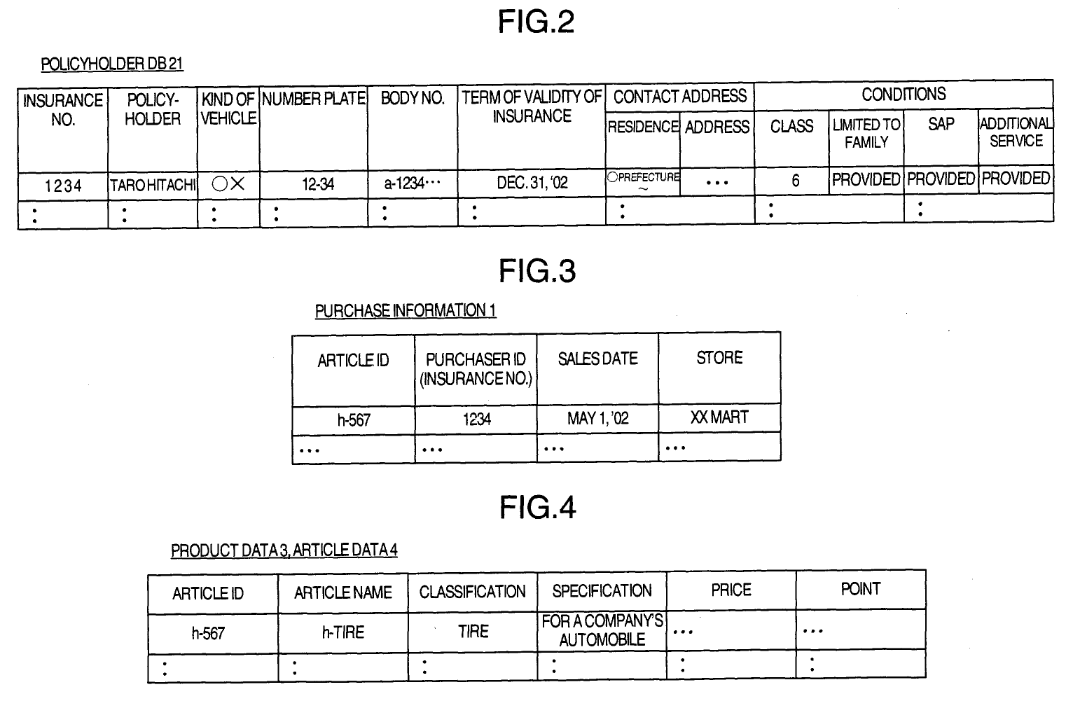

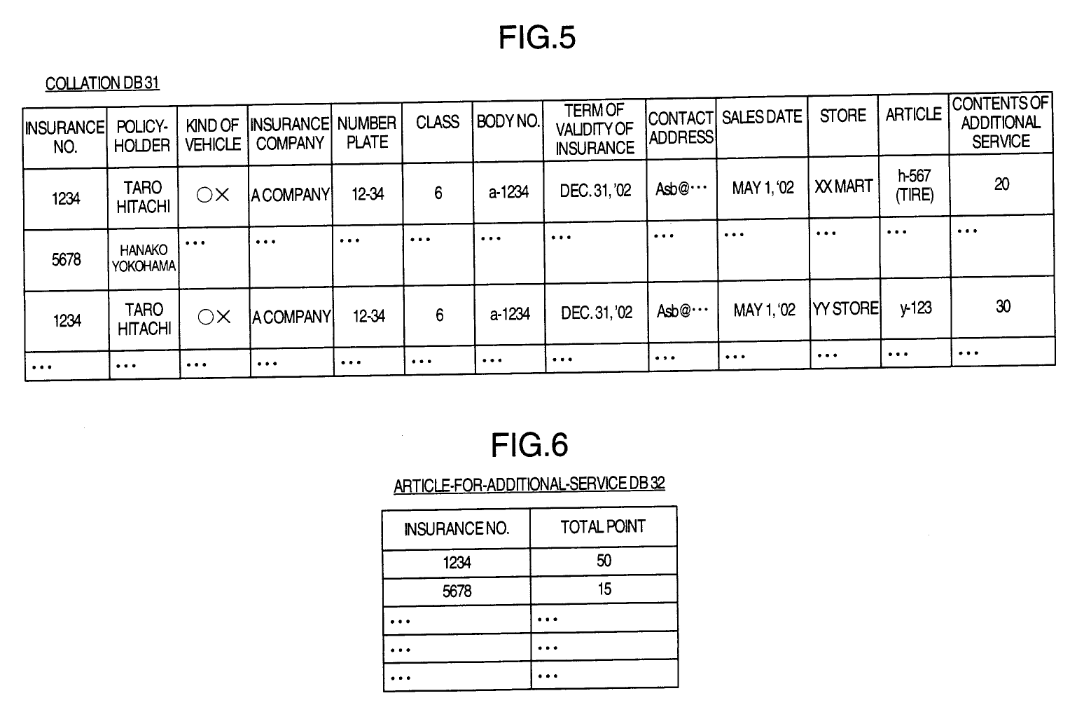

In step 101, the collation system 30 registers policyholder information 2 shown in FIG. 11 and transmitted from each of the insurance company servers 20 in step 100 into the policyholder DB 21 shown in FIG. 2. The collation system 30 registers the policyholder information 2 representing contents of the insurance containing an insurance number for identifying automobile insurance. The policyholder information 2 contains information containing insurance numbers and policyholder's names for identifying policyholders, information for identifying kinds of vehicles insured, information of number plates of vehicles insured and mail addresses of policyholders. Further, the mail address may be a destination of PR data transmitted to a policyholder in step 114 described later.

Further, in step 103, the store server 40 registers product data 3 containing an article identifier (ID) for identifying an article of commerce as shown in FIG. 4 into an article database (DB) 41 shown in FIG. 8. The product information 3 contain information transmitted from the maker server 50 in step 102. Further, the product information 3 contain information inputted to the store server 30 from the persons concerned in the store.

Next, in step 104, the store server 40 executes application processing of an additional service registration to the insurance company server 20. In the embodiment, the store server 40 transmits application information 5 containing article information 4 to the insurance company server 20. The article data 4 is to be based on the article DB 41.

The article information 4 contains article IDs, article names, article classification indicating classification of articles, specification indicating specification of articles such as kinds of suitable vehicles, selling prices and points given to the articles. The points are to be issued for sale of articles. Further, the store server 40 may transmit individual application information 5 corresponding to each of the plurality of insurance company servers 20. That is, the store server 40 may transmit the application information containing the article information 4 having a different point even if the article is identical. Further, the points contain individual points in accordance with the kind of vehicles or contents of the insurance (particularly, class and premium).

Next, in step 106, the insurance company server 20 executes judgment processing as to whether the application information 5 received in step 105 can be registered or not. The collation system 30 executes judgment processing in accordance with the relation of the points and predetermined information. The collation system 30 executes the judgment processing in accordance with whether the first correspondence relation of the predetermined information indicated in the correspondence table and permissible points and the second correspondence relation of the predetermined information inputted in step 105 and the points have the predetermined relation or not. The first correspondence relation is not shown particularly.

For example, when the second correspondence relation satisfies the first correspondence relation, the judgment for permitting the registration is executed. Characteristic information of articles containing prices and identification of articles is stored as predetermined relation in the correspondence table. In this case, permitted points are stored as an example of the first correspondence relation in accordance with a value indicated by the characteristic information. For example, the first correspondence relation is set so that the higher the price of the article is the larger the value of the point becomes.

The embodiment contains that the user of the insurance company server 20 executes final judgment in step 106. In this case, the insurance company server 20 may output the correspondence table and the application information 5. The users contain the person who utilizes the insurance company server 20 by means of a terminal unit that can utilize the insurance company server 20.

Next, when the judgment in step 106 is negative, the insurance company server 20 notifies that fact to the store server 40 in step 107. In step 111, the store server 40 receives it and outputs it or stores it in a predetermined memory area.

Further, when the judgment in step 106 is affirmative, the process proceeds to step 108. In step 108, the result of judgment containing the application information 5 is transmitted to the collation system 30. The application information 5 contains information indicative of similar contents in addition to the information transmitted in step 104.

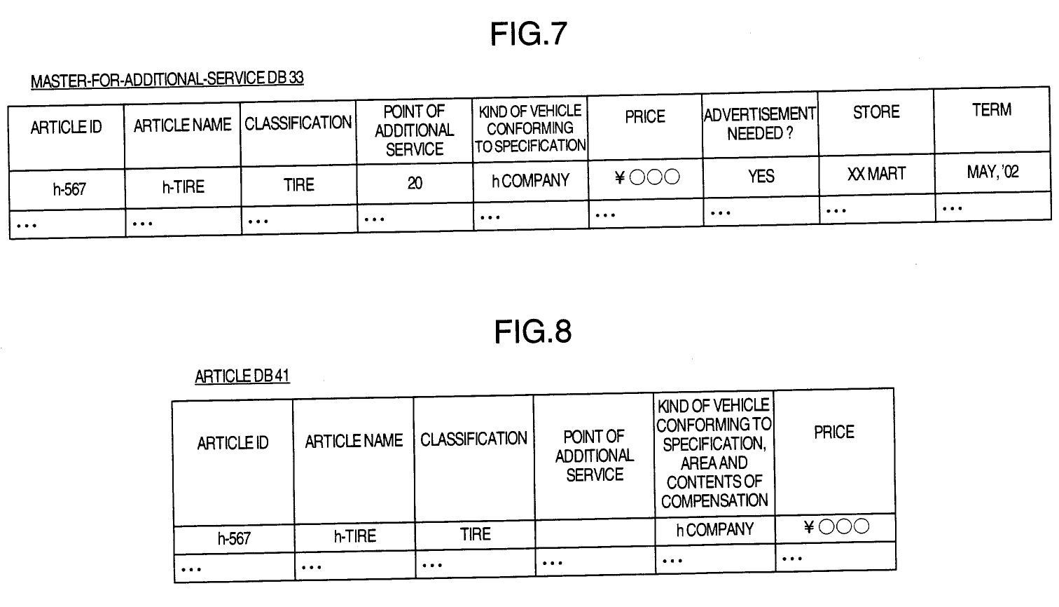

Next, in step 109, the collation system 30 registers the application contents indicated in the transmitted application information 5 to a master-for-additional-service DB 33 shown in FIG. 7. That is, the article information 4 containing the article ID and the given points are stored in corresponding manner to each other. In this case, information for specifying the store may be stored in a correspondence manner thereto in addition thereto.

Next, in step 110, the collation system 30 informs the registration information to the store server 30. The informed registration information contains the information indicating that the registration has been made, and the article information 4 and the points which are the registered contents. Information for specifying a store may be contained in the informed registration information. The informed registration information is received by the store server 20 in step 112. The store server 40 executes at least one of outputting and registering of the contents of the received registration information.

The stores contain not only a single store but also a plurality of stores such as a chain store. In case of the plurality of stores, information for specifying a store may be contained. The registration information may be broadcast to the store servers managed by the plurality of stores.

Next, processing subsequent to step 113 which is additional processing in the embodiment is now described. In step 113, the collation system 30 confirms the registration contents. That is, whether the registration contents require advertisement or not is judged. This judgment is made on the basis of advertisement information contained in the registration contents. The advertisement information is contained in the application information 5 and indicates whether advertisement is required or not. Further, when the advertisement information indicates that advertisement is required, the advertisement information also contains information relative to parties receiving advertisement. In other words, in step 104, the store server 40 transmits the application information 5 with the advertisement information contained therein. The store server 40 receives the information indicating whether the advertisement is required or not (or at least one thereof) and prepares the application information 5 in accordance with the received contents to transmit it.

When the advertisement is required, the mail addresses of the parties receiving advertisement are added. The mail addresses may be extracted from customer information possessed by the store server 40 or may be inputted by hand. Further, when the customer information is extracted, the mail addresses of the customers having information indicative of tendency of purchase and corresponding to the article information 4 contained in the application information 5 are extracted. In the embodiment, information for implementing electronic or non-electronic advertisement to the customers (parties receiving advertisement) may be utilized in addition to the mail addresses. The mail addresses represent the addresses of the policyholder terminals 10 in the embodiment and the policyholder terminals 10 include information processing units containing personal computers and portable telephones.

When it is judged that the advertisement is required in step 113, the collation system 30 delivers the advertisement information to the mail addresses in step 114. The delivered advertisement information contains the article information 4 contained in the application information 5.

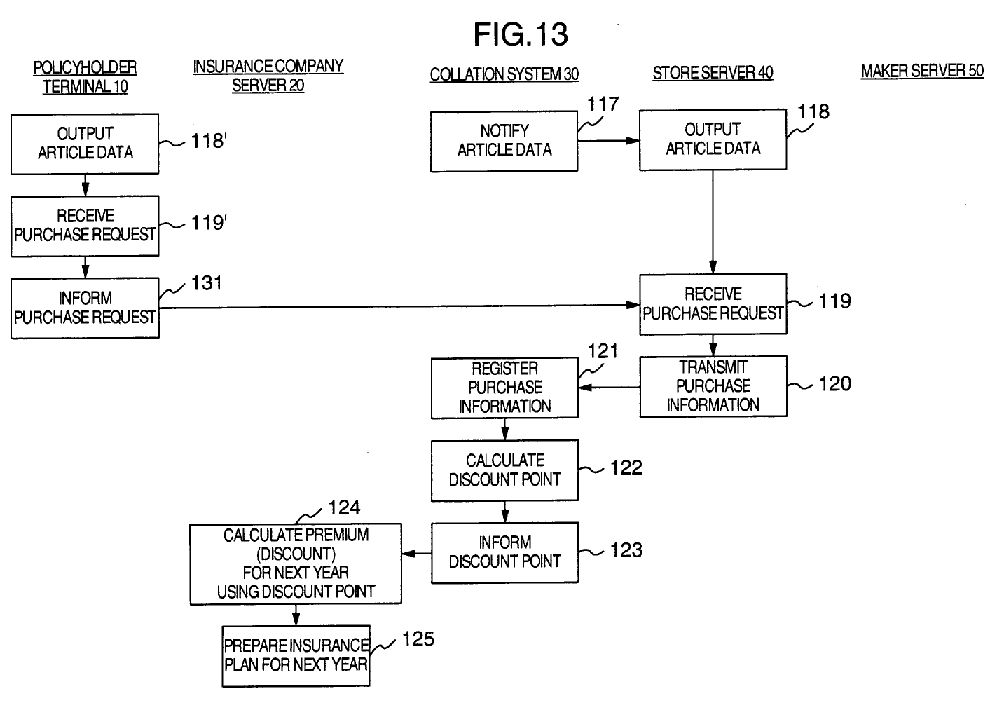

The foregoing is the description of the first processing. Next, second processing in the embodiment is described with reference to FIG. 13. The second processing is processing concerning the service such as giving of points and a discount of the insurance premium.

First, in step 117, the collation system 30 notifies the article information 4 containing the points conforming to the contents registered in step 109 to the store server 40.

In step 118, the store server 40 outputs the notified article information 4. Further, the article information 4 may be outputted to the store terminals 45 containing POS terminals connected to the store server 40, advertisement boards and the like. The processing in steps 117 and 118 is selective processing and may not be executed. Further, as shown in step 118′, the advertisement information may be outputted by the policyholder terminal 10.

The article information outputted may be as follows: The article information of the article corresponding to the kind of vehicle indicated in the policyholder DB 21 or a collation DB 31 may be outputted. When the article information is transmitted to the policyholder terminal 10, the collation DB 31 is used while using the mail address of the destination of transmission as a key to specify the kind of vehicle. Even in step 114 described above, the advertisement information may be also delivered similarly. Further, when the article information is transmitted to the store server 40, the information for specifying the insurance such as the insurance number is received from a purchaser or the like and this information and the collation DB 31 are used to specify the kind of vehicle.

In step 119, the store server 40 receives a purchase request of an article to be given points containing the article information 4 and information for specifying the purchaser. Here, the store server 40 may judge whether the article of the inputted article information 4 is to be given points or not. In step 112, it is judged in accordance with the registered contents whether the article of the received article information 4 is to be given points or not. Further, the policyholder terminal 10 may receive the purchase request from a consumer (policyholder) in step 119′. In this case, in step 131, the policyholder terminal 10 informs the information indicative of the purchase request to the store server 40.

Further, the input of the purchase request contains (1) input from the policyholder terminal 10, (2) input from the user to the store server 40 and (3) input from the store terminal 45 such as the POS terminal and the register connected to the store server 4.

Next, in step 120, the store server 40 transmits the purchase information 1 shown in FIG. 3 to the collation system 30. The purchase information 1 contains the article information 4, the information for specifying the purchaser and the information for specifying the store (or store server 30). The insurance number for specifying the automobile insurance of the purchaser is used as the information for specifying the purchaser. Further, the information for specifying the purchaser may be to specify any of the purchaser himself or the automobile insurance of the purchaser.

Next, in step 121, the collation system 30 registers the purchase information 1 in the collation DB 31. In this case, the purchase information is registered in a correspondence manner to the policyholder information registered in step 101.

Next, in step 122, the collation system 30 calculates the total point for each insurance number. In this calculation, the collation DB 31 is subjected to sorting processing while using the insurance number as a key to prepare an article-for-additional-service DB 32 shown in FIG. 6. This calculation processing may be performed for each insurance number at the time conforming to the term of validity of the insurance indicated in the collation DB 31. For example, the total points may be calculated a predetermined time before the term of validity of the insurance. In this case, the total point can be utilized for a discount in a next updated insurance contract. Further, when a request is issued from the insurance company server 20, the calculation processing may be performed.

In step 123, the collation system 30 transmits the total point calculated for each insurance number to the insurance company server 20. The insurance company server 20 of the destination is an insurance company server corresponding to the insurance company contained in the collation DB 31. That is, the total point is informed to the insurance company server of the insurance company which deals with the insurance corresponding to the insurance number.

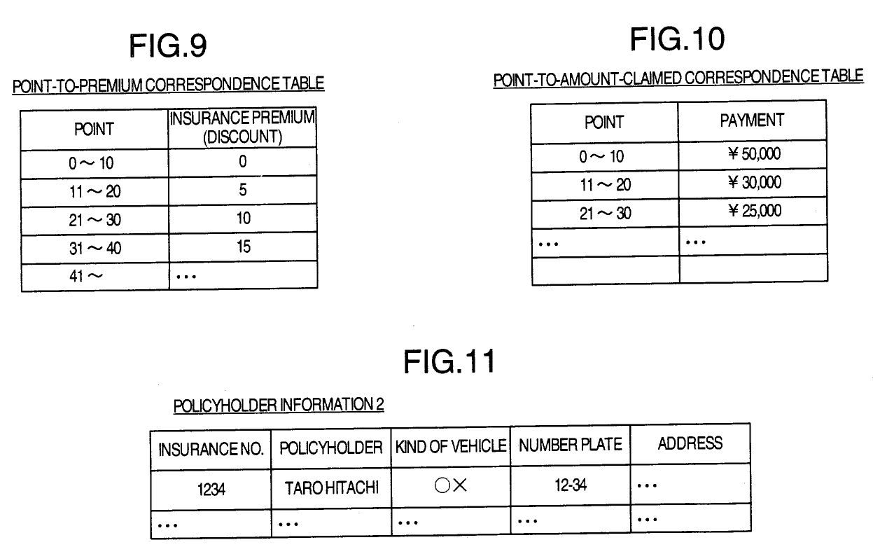

Next, in step 124, the insurance company server 20 informed of the total point calculates the next premium for the next year. The insurance company server 20 calculates the premium which is the payment on the basis of a point-to-amount-claimed correspondence table 34 shown in FIG. 10. In the embodiment, the point-to-amount-claimed correspondence table 34 is provided for each predetermined unit containing the class. Further, a point-to-premium correspondence table 22 shown in FIG. 9 may be used to calculate the premium to be discounted and the payment may be calculated from the calculated premium to be discounted. The point-to-premium correspondence table 22 is also provided for each unit containing the class similarly to the point-to-amount-claimed correspondence table 34.

In the embodiment, the processing in step 124 is performed by the insurance company server 20, although it may be performed by the collation system 30. In this case, the collation system 30 includes the point-to-premium correspondence table 22 and the point-to-amount-claimed correspondence table 34. These tables are used to perform the processing in step 122 and implement the processing in step 124. The calculated premium is informed to the insurance company server 20 corresponding thereto. Further, the collation system 30 may calculate the discount premium and the insurance company corresponding thereto may calculate the premium on the basis of the discount premium.

Next, the insurance company server 20 prepares the next insurance plan on the basis of the premium calculated in step 124. In the embodiment, the class may be calculated in step 124 similarly to the premium.

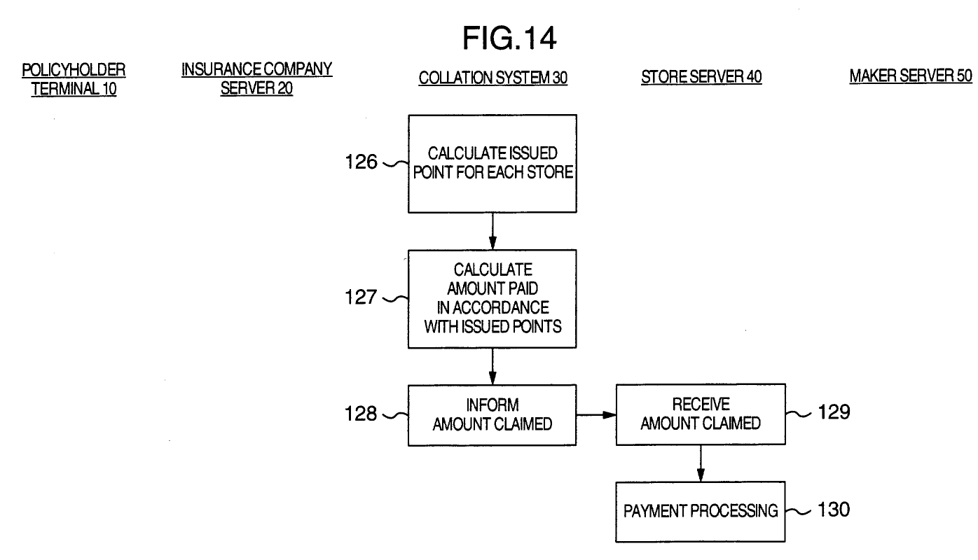

The foregoing is the description of the second processing. Next, third processing is described with reference to FIG. 14. The third processing is settlement of accounts in giving of the service.

First, in step 126, the collation system 30 calculates the issued points for each predetermined unit containing the store. The collation system 30 subjects the collation DB 31 to sorting processing while using the store as a key to calculate the total of the issued points for each store.

Next, in step 127, the collation system 30 calculates the amount to be borne in accordance with the issued points. First, the table representing the correspondence relation of the points and the amount of money, similarly to the point-to-premium correspondence table 22 and the point-to-amount-claimed correspondence table 34, is used to decide the amount claimed for each store.

Next, in step 128, the collation system 30 informs the calculated amount claimed to each store server 40. The store server 40 informed of the calculated amount claimed in step 129 performs the processing for settling the amount claimed in step 130. Here, the processing for paying the amount claimed to the system managing the collation system 30 is performed. This processing contains transfer to an account of a bank.

In the embodiment, the collation system 30 may perform processing for payment to each insurance company. In this case, the collation system 30 subjects the collation DB 31 to sorting processing while using the insurance company as a key to calculate the total point of each insurance company and performs processing for implementing payment of the amount corresponding to the calculated total point to each insurance company.

Further, in regard to the processing following step 126, the following processing is also contained in the embodiment. First, in step 126, the issued points calculated in each store are subdivided for each insurance company to be calculated. To this end, the collation DB 31 is subjected to sorting processing while using the store as key to calculate the points for each store. Then, the sorted data are subjected to sorting processing while using the insurance company as a key and the points for each store are subjected to sorting processing while using the insurance company as a key. Consequently, the points subdivided for each insurance company can be calculated.

Next, in step 127, the calculated points are converted into the amount claimed. In steps 128 and 129, the amount claimed for each insurance company is informed to the store servers 40 of the stores issuing the points.

Next, in step 130, the store servers 40 informed of the amount claimed perform the processing for payment (settlement) to each insurance company. This processing contains processing for transfer to an account similarly to the above-mentioned case.

The foregoing is the description of the embodiment. In the embodiment, the points are used to reduction of the insurance premium in the automobile insurance, while the points may be used to other additional services. According to the embodiment, there can be easily provided the system for offering the additional service to the action such as purchase of equipment relative to the automobile.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A system for calculating an insurance premium, said system including an insurance company server managed by an insurance company which provides automobile insurance and a store server managed by a store which sells equipment relative to an automobile, said insurance company server and said store server being connected through a network, and comprising:
a storage apparatus for storing points previously defined for each equipment and a program;
a receiving apparatus for receiving purchase information of equipment containing an equipment identifier for specifying equipment purchased and an insurance identifier for specifying automobile insurance of a purchaser of the equipment from said store server; and
a control apparatus connected to said storage apparatus and said receiving apparatus, for calculating points corresponding to the equipment identifier on the basis of said received equipment identifier and said storage means in accordance with said program and controlling to store said insurance identifier and said calculated points in a correspondence manner to each other in said storage means, said control apparatus calculating a total value of the points corresponding to said insurance identifier every fixed period defined by the automobile insurance specified by said insurance identifier and calculating information relative to an updated insurance premium of said automobile insurance on the basis of said total value.

2. An insurance premium calculation system according to claim 1, wherein:
said storage apparatus stores, for each insurance identifier, class information indicative of a class of the automobile insurance specified by said insurance identifier, and
said control apparatus calculates information relative to the insurance premium by using a table which is prepared for each class indicated by said class information and in which the points and information relative to the insurance premium are stored in a correspondence manner to each other.

3. An insurance premium calculation system according to claim 1, wherein
said control apparatus calculates, as information relative to the insurance premium, information indicating at least one of a premium of the insurance and a discount of the premium of the insurance.

4. An insurance premium calculation system according to claim 1, wherein
said control apparatus calculates, as information relative to the insurance premium, information indicating a class of the insurance.

5. An insurance premium calculation system according to claim 1, wherein:
said receiving apparatus receives purchase information containing a store identifier for identifying said store, and
said control apparatus controls to store said store identifier in said storage means in a correspondence manner to said insurance identifier and said calculated points, and uses said store identifier to calculate the total value of the points for each store for the fixed period.

6. An insurance premium calculation system according to claim 5, wherein
said control apparatus stores an insurance company identifier indicative of an insurance company issuing insurance specified by said insurance identifier in a correspondence manner to the insurance company in said storage means, and calculates the total value of points for said fixed period of each insurance company for each total value of points for each store on the basis of the total value of points for each store and said insurance company identifier.

7. An insurance premium calculation method using an insurance premium calculation system including an insurance company server managed by an insurance company which provides automobile insurance, a store server managed by a store which sells equipment relative to an automobile, and storage means connected to said insurance company server and said store server through a network, for storing points previously defined for each equipment, comprising:
a step of receiving purchase information of equipment containing an equipment identifier for specifying equipment purchased and an insurance identifier for specifying automobile insurance of a purchaser of the equipment from said store server;
a step of calculating points corresponding to the equipment identifier on the basis of the received equipment identifier and said storage means to store said insurance identifier and said calculated points in a correspondence manner to each other in said storage means;
a step of calculating a total value of the points corresponding to said insurance identifier every fixed period defined by the automobile insurance specified by said insurance identifier; and
a step of calculating information relative to an updated insurance premium of the automobile insurance on the basis of the total value.

8. An insurance premium calculation method according to claim 7, wherein:
said storing step includes storing, for each insurance identifier, class information indicative of a class of the automobile insurance specified by said insurance identifier, and
said step of calculating the insurance premium includes calculating information relative to the insurance premium by using a table which is prepared for each class indicated by said class information and in which the points and information relative to the insurance premium are stored in a correspondence manner to each other.

9. An insurance premium calculation method according to claim 8, wherein
said step of calculating the insurance premium includes calculating, as information relative to the insurance premium, information indicating at least one of a premium of the insurance and a discount of the premium of the insurance.

10. An insurance premium calculation method according to claim 8, wherein
said step of calculating the insurance premium includes calculating, as information relative to the insurance premium, information indicating a class of the insurance.

11. An insurance premium calculation method according to claim 7, wherein:
said receiving step includes receiving purchase information containing store identifier for identifying said store,
said storing step includes a step of storing said store identifier in said storage means in a correspondence manner to said insurance identifier and said calculated points, and
said method further comprises a step of using said store identifier to calculate the total value of the points for each store for the fixed period.

12. An insurance premium calculation method according to claim 11, wherein:
said storing step further includes a step of storing insurance company identifier indicative of an insurance company issuing insurance specified by said insurance identifier in a correspondence manner to the insurance company in said storage means, and
said method further comprises a step of calculating the total value of points for said fixed period of each insurance company for each total value of points for each store on the basis of the total value of points for each store and said insurance company identifier.

13. A program product stored in a storage medium readable by a computer connected through a network to an insurance company server managed by an insurance company which provides automobile insurance and a store server managed by a store which sells equipment relative to an automobile, said program product causing said computer to execute the following steps comprising:
a step of storing points previously defined for each equipment;
a step of receiving purchase information of equipment containing an equipment identifier for specifying equipment purchased and an insurance identifier for specifying automobile insurance of a purchaser of the equipment from said store server;
a step of calculating points corresponding to the equipment identifier on the basis of the received equipment identifier and storage means, and controlling to store said insurance identifier and said calculated points in a correspondence manner to each other in said storage means;
a step of calculating a total value of the points corresponding to said insurance identifier every fixed period defined by the automobile insurance specified by said insurance identifier; and
a step of calculating information relative to an updated insurance premium of said automobile insurance on the basis of said total value.

14. A program product according to claim 13, wherein:
said storing step includes storing, for each insurance identifier, class information indicative of a class of the automobile insurance specified by said insurance identifier, and
said step of calculating information relative to the insurance premium includes calculation using a table which is prepared for each class indicated by said class information and in which the points and information relative to the insurance premium are stored in a correspondence manner to each other.

15. A program product according to claim 13, wherein
said step of calculating information relative to the insurance premium includes calculating, as information relative to the insurance premium, information indicating at least one of a premium of the insurance and a discount of the premium of the insurance.

16. A program product according to claim 14, wherein
said step of calculating information relative to the insurance premium includes calculating, as information relative to the insurance premium, information indicating a class of the insurance.

17. A program product according to claim 13, wherein:
said receiving step includes receiving purchase information containing store identifier for identifying the store, and
said controlling step includes a step of controlling to store said store identifier in said storage means in a correspondence manner to said insurance identifier and said calculated points, and
said program product further comprises a step of using said store identifier to calculate the total value of points for each store for the fixed period.

18. A program product according to claim 17, wherein:
said controlling step further includes a step of storing an insurance company identifier indicative of an insurance company issuing insurance specified by said insurance identifier in a correspondence manner to the insurance company in said storage means, and
said program product further comprises a step of calculating the total value of points for said fixed period of each insurance company for each total value of points for each store on the basis of the total value of points for each store and said insurance company identifier.
